(19) United States
(12) Patent Application Publication
(10) Pub. No.: US 2022/0177213 A1
(43) Pub. Date: Jun. 9, 2022

(54) MOBILE SELF-POWERED CRYO CHILLER

(71) Applicant: Dalrada Health Products, Escondido, CA (US)

(72) Inventor: David Pickett, Escondido, CA (US)

(21) Appl. No.: 17/547,208

(22) Filed: Dec. 9, 2021

Related U.S. Application Data
(60) Provisional application No. 63/124,028, filed on Dec. 10, 2020.
(60) Provisional application No. 63/123,442, filed on Dec. 9, 2020.

(51) Int. Cl. B65D 81/18; F25D 3/10; F17C 13/00

(52) U.S. Cl. CPC B65D 81/18; F25D 3/105; A01N 1/0221; F17C 2223/0161; F17C 2270/01; F17C 13/001

(57) ABSTRACT

The subject matter described herein relates to a mobile solution and processes for transporting products that require to be maintained at temperatures from −5° C. to −80° C., as well as a non-mobile option. The subject matter includes systems, methods, and devices that include a power system, a refrigeration system, a storage unit comprising a compartment configured to hold the temperature sensitive material, and a mobile storage structure configured to house the power system, the refrigeration system, and the storage unit

### TECHNICAL FIELD

The subject matter described herein relates to cooling technologies and, more specifically, to mobile and non-mobile cooling technologies and processes for transporting products at temperatures from −5° C. to −80° C.

### BACKGROUND

Some drug and biomaterial products, including vaccines and blood plasma, must be kept at very low temperatures during shipment and prior to administration. With the advent of mRNA vaccines, including the new COVID-19 vaccines, this requirement is a growing impediment to vaccine distribution. Such cold storage is difficult due to a lack of reliable, mobile solutions. Currently, dry ice and refrigeration are the primary methods used during transport, which both have major drawbacks. Devices and methods for mobile deep-cold storage, as well as non-mobile storage at clinics, hospitals, camps, and administration facilities, are needed.

### SUMMARY

The cooling technologies described herein enable the safe movement and storage of vaccines and other products that are required to be distributed across the country into remote regions. The cooling technologies, or Cryo chillers, enable low-income regions to create local centers for storage of the current vaccines to help fight the coronavirus SARS-CoV-2 (COVID-19) pandemic. Additionally, the non-mobile solution may enable hospitals and other facilities to upgrade their ability to store and dispense the products requiring very low temperatures.

This solution incorporates unique supercritical carbon dioxide Cryo chillers. The carbon dioxide Cryo chillers function on the utilization of radiant cooling with stainless steel-sandwiched roof and sidewall liners incorporated into an internal piping construction. This structure may enable the flow of silicone-based solution and other relevant transfer fluids to flow into the storage unit at −75° C. and flow out at −65° C., then cycle through and return through the Cryo chiller. This configuration and customization into a self-contained and powered unit are unique at temperatures of −75° C. The non-mobile solution may enable hospitals, clinics, and any other facility to become a storage/distribution point for dispensing products that need critical temperature control.

In some variations, one or more of the following features may optionally be included in any feasible combination, all applications of our mobile and non-mobile unit are cross developable.

A device for transporting and storage of temperature-sensitive materials may include a generator power solution. The device may include a Cryo cooling chiller. The device may include a chiller storage unit. The device may include a continuous flow process to the chiller storage unit, enabling the chiller storage unit to maintain a temperature of between about −5° C. and about −80° C. The device may include a condensed mobile structure and non-mobile structure.

The generator may create sufficient power to run the Cryo cooling chiller directly from solar or propane tank. The cryo cooling chiller may cool the storage structure to between about −50° C. and about −80° C. The cryo cooling chiller may cool the storage structure to about −75 ° C. The generator power solution may be a mobile structure. The temperature-sensitive materials can be safely stored and/or transported in the chiller storage unit.

A device for transportation and/or storage of a temperature-sensitive material may include a power system. The device may include a refrigeration system. The device may include a storage unit comprising a compartment configured to hold the temperature-sensitive material. The device may include a storage structure configured to house the power system, the refrigeration system, and the storage unit.

The power system may be configured to provide sufficient power to run the refrigeration system for a period of at least 15 days without recharging. The power system may include a generator, solar panels, batteries, or wired electricity. The generator may be fueled by natural gas, propane, or other fuel.

The refrigeration system may be configured to cool the storage unit to between about −5° C. and about −80° C. The storage unit may be supercritically chilled using carbon dioxide.

The storage structure may be configured to be mobile. The storage structure, the power system, the refrigeration system, and the storage unit may include a self-contained, closed system.

The device may be remotely monitored in real-time. The device may be configured to remotely control one or more device settings, including temperature, humidity, pressure, flow, location, stability, power consumption, power remaining, and storage capacity remaining.

The storage unit may include a plurality of compartments configured to hold the temperature-sensitive material.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### BRIEF DESCRIPTION OF THE DRAWINGS

The accompanying drawings, which are incorporated into and constitute a part of this specification, show certain aspects of the subject matter disclosed herein and, together with the description, help explain some of the principles associated with the disclosed implementations. In the drawings:

FIG. 1A illustrates a side view of an embodiment of a mobile Cryo chiller 120 storage solution;

FIG. 1B illustrates a top view of an embodiment of a mobile Cryo chiller 120 storage solution;

FIG. 2A illustrates a front view of an embodiment of a non-mobile Cryo chiller 120 storage solution;

FIG. 2B illustrates a back view of an embodiment of a non-mobile Cryo chiller 120 storage solution;

FIG. 3A illustrates an angled view of a schematic of a non-mobile Cryo chiller 120 storage solution;

FIG. 3B illustrates a side view of a schematic of a non-mobile Cryo chiller 120 storage solution;

FIG. 3C illustrates a front view of a schematic of a non-mobile Cryo chiller 120 storage solution;

FIG. 3D illustrates a back view of a schematic of a non-mobile Cryo chiller 120 storage solution;

FIG. 4 illustrates a frame for a non-mobile Cryo chiller storage solution;

FIG. 5 illustrates a compressor system for a non-mobile Cryo chiller storage solution;

FIG. 6 illustrates a compressor system for a non-mobile Cryo chiller storage solution;

FIG. 7 illustrates an interface paneling for a non-mobile Cryo chiller storage solution;

FIG. 8 illustrates an environment for a non-mobile Cryo chiller storage solution;

FIG. 9 illustrates a specification sheet for a non-mobile Cryo chiller storage solution;

FIG. 10 depicts a flowchart illustrating an example of a process for maintaining a temperature in a Cryo chiller storage solution, in accordance with some example embodiments; and

FIG. 11 depicts a block diagram illustrating a computing system, in accordance with some example embodiments.

### DETAILED DESCRIPTION

A mobile modular chilling solution with the ability to maintain the temp at −75° C. with a generator solution or other power solutions that have the ability to run for up to 15 days without refilling or recharging the freezing or cooling mechanism (i.e., dry ice, refrigeration systems) has not been previously available on the market. Also, the non-mobile cooling solution has the ability to run efficiently either hard-wired into the main building power or run on an efficient generator solution.

The Cryo cooling system includes carbon dioxide-based heat pumps that may reduce the demand for energy and water and maximize the output of renewable energy sources. The Cryo cooling system may harvest energy that would traditionally be lost, reducing energy consumption by up to 75% in comparison to conventional systems. The result may be a safe, innovative combustion-free heat in the low-temperature cooling system that requires no burning of fossil fuels.

Further, this solution can solve the problems of vaccine waste due to quality and temperature control. Additionally, the Cryo cooling system provides a green energy solution that runs on supercritical carbon dioxide with an extremely low global warming potential and an efficient system that may require minimal power to produce sub-zero temperatures. As a mobile and turnkey cool storage solution (end to end), the Cryo cooling system may be multi-purpose for transport and cool storage needs within a facility. Other benefits include an ultra-low GWP of just 1,357 (90% less than R-232) with zero ozone-depleting potential to work with applications down to −97° F.

Implementations of the current subject matter include methods, apparatuses, articles of manufacture, and systems relating to a mobile or a non-mobile Cryo chiller 120 storage solution are found herein.

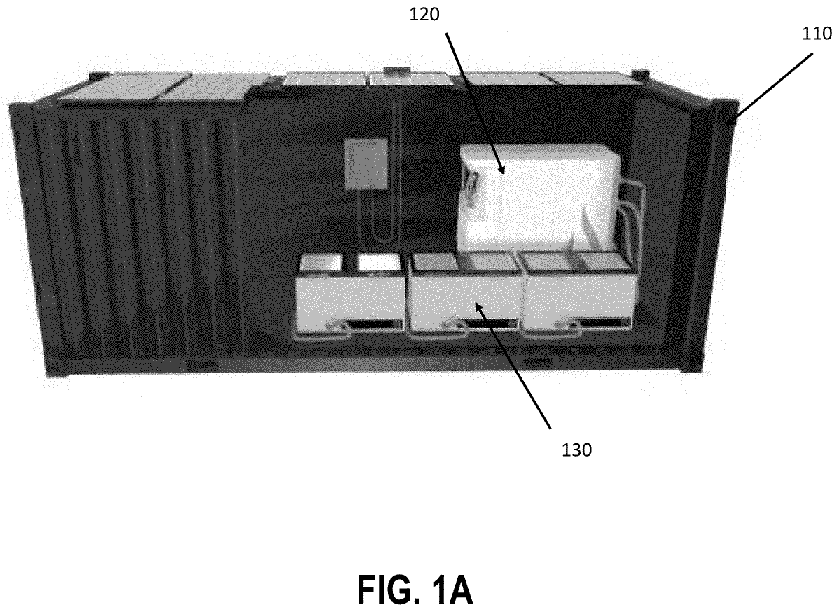

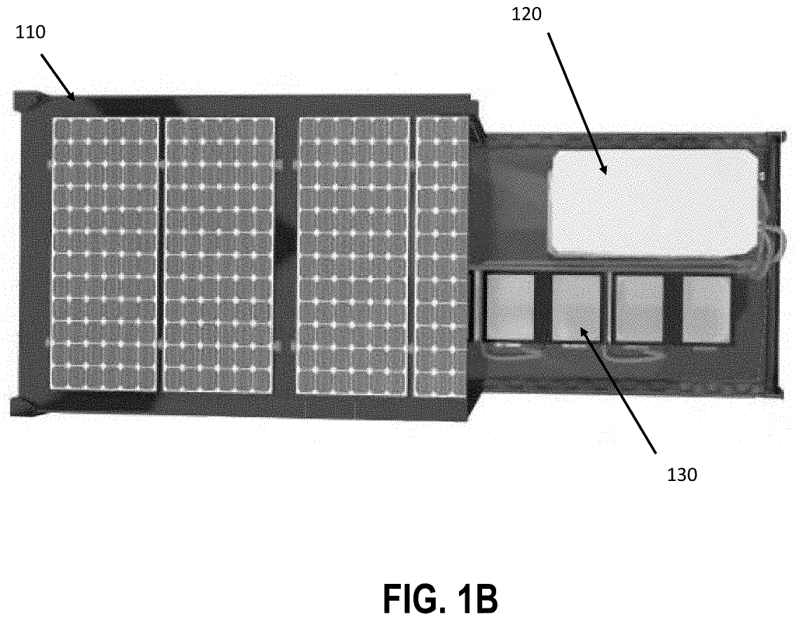

FIG. 1A illustrates a side view of an embodiment of a mobile Cryo chiller 120 storage solution. The mobile Cryo chiller 120 may include a self-contained power solution, a Cryo chiller 120 unit, a cooler box 130, a self-sustainability power solution, a propane power solution, and a remote temp monitoring and controls for the Cryo chiller 120, storage unit, and power generator. The Cryo chiller 120 unit and cooler box 130 may be included inside of enclosure 110. The enclosure 110 may be provided to house one or more components of the Cryo chiller 120, such as the refrigeration system and/or a power system. The enclosure 110 may include a mobile container configured to house the Cryo chiller 120 and cooler box 130 es in regions requiring critical products, including on sea, air, and ground regions. The enclosure 110 may be a fully enclosed frame with quick-release panels and a drip tray. The enclosure 110 may be a genuinely modular solution that scales out horizontally rather than vertically. In some embodiments, the enclosure 110 may include soundproofing.

The Cryo chiller 120 may be a refrigeration system configured to maintain temperatures less than 0° C. The Cryo chiller 120 may use a two-stage technology to produce very low temperatures below −40° F. with a single ultra-low Global Warming Potential (GWP) refrigerant. The Cryo chiller 120 may use carbon dioxide to maintain a consistent temperature from −1° C. to −80° C. in a closed-loop process. For example, in some embodiments, the temperature range may be between about −5° C. and about −80° C. The Cryo chiller 120 may be supercritically chilled using carbon dioxide. In some embodiments, the Cryo chiller 120 may cool a 20-foot space to about −75° C. Such smaller structures may be connected together as a sealed unit for use in, for example, a hospital. In some embodiments, a generator may be used for mobile operation, or the Cryo chiller 120 may be plugged directly into the wall of a facility where the generator may be used as backup.

The function of the Cryo chiller 120 may be to maintain the temperature of the cooler box 130 at or below −75° C. The silicone-based fluid or other relevant heat transfer fluid flows may round the system without freezing. The silicone-based fluid or other relevant heat transfer fluid and may be either at −75° C. or −65° C. when it comes out of the Cryo chiller 120. In some embodiments, the Cryo chiller 120 has the ability to cool about 70 square feet of space to about −75° C. An expansion vessel and nitrogen blanketing may be used to prevent atmospheric moisture.

In some embodiments, the temperature range may be between about −5° C. and about −80° C. In some embodiments, the temperature range may be between about −10° C. and about −80° C. In some embodiments, the temperature range may be between about −20° C. and about −80° C. In some embodiments, the temperature range may be between about −30° C. and about −80° C. In some embodiments, the temperature range may be between about −40° C. and about −80° C. In some embodiments, the temperature range may be between about −50° C. and about −80° C. In some embodiments, the temperature range may be between about −60° C. and about −80° C. In some embodiments, the temperature range may be between about −70° C. and about −80° C. In some embodiments, the temperature range may be about −5° C., −10° C., −20° C., −30° C., −40° C., −50° C., −60° C., −70° C., −75° C., or −80° C. The temperature range may be any value or subrange within the recited range, including endpoints.

For applications between −5 and −45° C., the Cryo chiller 120 may use 100% pure R744 carbon dioxide or a Zeotropic refrigerant. Cryo chiller 120 may work below −45° C. using a R-469A, a zeotropic refrigerant, based on a mixture of R-744 (CO₂) and R410. R-469A has a Global Warming Potential (GWP) of 1,357 and no ozone-depleting potential. R-469A may meet all refrigerant requirements for environmental simulation. Other features of R-469A may include being non-flammable, non-toxic, non-corrosive, and chemically stable.

The self-contained power solution may include an energy converter or power generator configured to receive energy at the enclosure 110. For example, the energy converter may include a power transform box configured to convert the incoming power to the desired voltage and amperage for the Cryo chiller 120. In another example, a power generator may be configured to convert a chemical source of energy to electricity at the desired voltage and amperage. The generator may be configured to provide power to the Cryo chiller 120. The generator may include a rotor configured to run at about 500 RPMs at a voltage of about 200 volts. The energy converter or power generator may use propane, natural gas, battery, and/or solar power to provide flexibility based on environmental conditions and cost requirements. A propane power solution may include a timeline before refill.

The power solution may be configured to harness a sustainable power source, such as a solar panel. The solar panel may be mounted to the top of the enclosure. Additionally, and/or alternatively, the sustainable power solution may be mounted to a side of the enclosure to receive a maximum amount of sunlight.

The cooler box 130 may be configured to insulated for maintaining a temperature within a temperature range, such as −5° C. to −80° C. The cooler box 130 may be configured to store biomaterials, vaccines, and other temperature-controlled products. The cooler box 130 may be very portable and easy to install. The cooler box 130 may be configured to daisy chain multiple containers together. The cooler box 130 may be configured to maintain a −75° C. temp for up to three days if the Cryo chiller 120 were to shut down. The cooler box 130 may be configured to store products for the semiconductor, chemical, nuclear, pharmaceutical, fuel, and food process industry. The cooler box 130 may be used for the winterization of CBD oils. The cooler box 130 may also be used to store varicella-containing vaccines at −50° C., including VAR, Varivax; ZOS, Zostavax; and MMRV, ProQuad. The cooler box 130 may be configured to store Chimpanzee adenoviral vectors vaccines at −70° C., including Ebola, coronaviruses, MERS CoV and SARS CoV along with recent vaccines treating Covid-19.

The Cryo chiller 120 may include monitoring and control features. The monitoring and control features may be configured to monitor and adjust settings such as temperature, humidity, and/or other settings. The monitoring and control features may control a flow rate of a single fluid and increase the likelihood of a relatively constant overall heat transfer coefficient regardless of a heating or chilling mode. The monitoring and control features may enable absolute temperature control that is replicable from one batch to another. The monitoring and control features may enable the standard temperature control variance to be within +/−0.5° C. to provide batch consistency and validated results.

The Cryo chiller 120 may include safety systems. The safety systems may include high-temperature switches, low-temperature switches, pressure relief valves, thermal fluid pressure switches, low-nitrogen pressure switches, low fluid dry-running detection, and high pressure in the compressor detection. In the case of exceeding allowable limits, the Cryo chiller 120 may be configured to shut down. Additionally, the Cryo chiller 120 may include a suction pressure sensor for freeze protection, a safety temperature limiter, a temperature sensor for a maximum allowable temperature of pressurized gas, and a motor protection sensor.

The Cryo chiller 120 includes various control features. The control features may include a user-interactive display with full diagnostic information & system overview, a large color screen, Ethernet (LAN/WAN) connectivity, WI-Fi connectivity, and 4G Internet connectivity. The Cryo chiller 120 may include cloud-based applications for remote monitoring, Site Service APP, real-time energy monitoring, and performance metering. The applications for the Cryo chiller 120 may be configured to have a full interface with customers with a DCS/SCADA/PCS System. The Cryo chiller 120 may include start/stop and emergency stop buttons. The applications for the Cryo chiller 120 may include built-in energy optimization functionality and a built-in web browser to present system information through either dashboards or automatically generated system graphics.

FIG. 1B illustrates a top view of an embodiment of a mobile Cryo chiller 120 storage solution. The flexibility of the mobile solution is that the Cryo chiller 120 and cooler box 130 may be taken out of the mobile unit, and placed in any facility as a standalone turnkey cool storage unit for hospitals, camps, pharmacies, clinics, and other facilities.

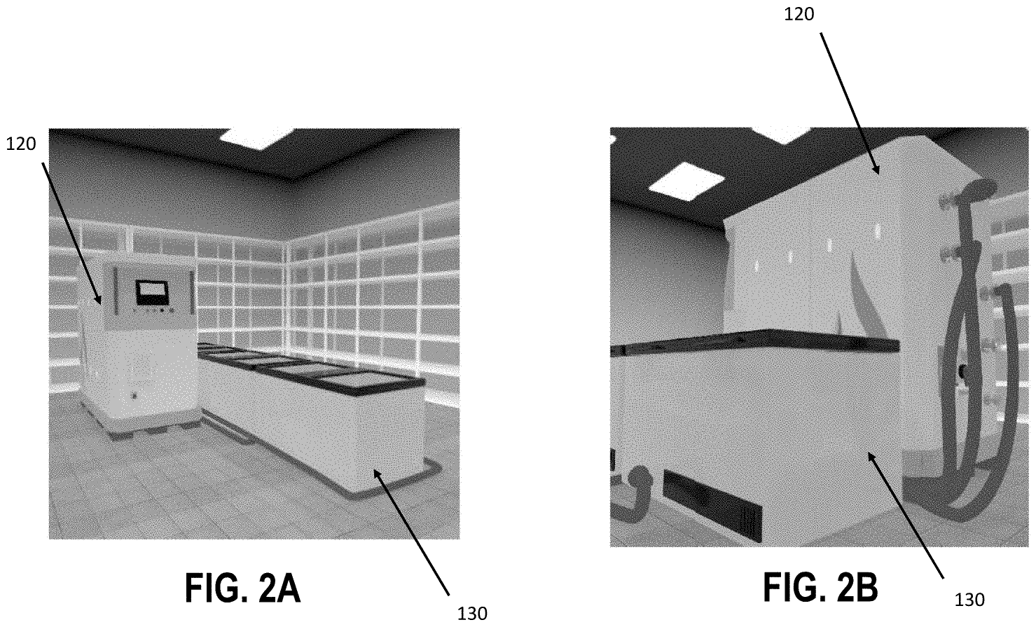

FIG. 2A illustrates a front view of an embodiment of a non-mobile Cryo chiller storage solution.

The Cryo chiller 120 may be a refrigeration system configured to maintain temperatures less than 0° C. The Cryo chiller 120 may use a two-stage technology to produce very low temperatures below −40° F. with a single ultra-low Global Warming Potential (GWP) refrigerant. The Cryo chiller 120 may use carbon dioxide to maintain a consistent temperature from −1° C. to −80° C. in a closed-loop process. For example, in some embodiments, the temperature range may be between about −5° C. and about −80° C. The Cryo chiller 120 may be supercritically chilled using carbon dioxide. In some embodiments, the Cryo chiller 120 may cool a 20-foot space to about −75° C. Such smaller structures may be connected together as a sealed unit for use in, for example, a hospital. In some embodiments, a generator may be used for mobile operation, or the Cryo chiller 120 may be plugged directly into the wall of a facility where the generator may be used as backup.

The function of the Cryo chiller 120 may be to maintain the temperature of the cooler box 130 at or below −75° C. The silicone-based fluid or other relevant heat transfer fluid flows may round the system without freezing. The silicone-based fluid or other relevant heat transfer fluid and may be either at −75° C. or −65° C. when it comes out of the Cryo chiller 120. In some embodiments, the Cryo chiller 120 has the ability to cool about 70 square feet of space to about −75° C. An expansion vessel and nitrogen blanketing may be used to prevent atmospheric moisture.

In some embodiments, the temperature range may be between about −5° C. and about −80° C. In some embodiments, the temperature range may be between about −10° C. and about −80° C. In some embodiments, the temperature range may be between about −20° C. and about −80° C. In some embodiments, the temperature range may be between about −30° C. and about −80° C. In some embodiments, the temperature range may be between about −40° C. and about −80° C. In some embodiments, the temperature range may be between about −50° C. and about −80° C. In some embodiments, the temperature range may be between about −60° C. and about −80° C. In some embodiments, the temperature range may be between about −70° C. and about −80° C. In some embodiments, the temperature range may be about −5° C., −10° C., −20° C., −30° C., −40° C., −50° C., −60° C., −70° C., −75° C., or −80° C. The temperature range may be any value or subrange within the recited range, including endpoints.

For applications between −5 and −45° C., the Cryo chiller 120 may use 100% pure R744 carbon dioxide or a Zeotropic refrigerant. Cryo chiller 120 may work below −45° C. using a R-469A, a zeotropic refrigerant, based on a mixture of R-744 (CO2) and R410. R-469A has a Global Warming Potential (GWP) of 1,357 and no ozone-depleting potential. R-469A may meet all refrigerant requirements for environmental simulation. Other features of R-469A may include being non-flammable, non-toxic, non-corrosive, and chemically stable.

The self-contained power solution may include an energy converter or power generator configured to receive energy at the enclosure 110. For example, the energy converter may include a power transform box configured to convert the incoming power to the desired voltage and amperage for the Cryo chiller 120. In another example, a power generator may be configured to convert a chemical source of energy to electricity at the desired voltage and amperage. The generator may be configured to provide power to the Cryo chiller 120. The generator may include a rotor configured to run at about 500 RPMs at a voltage of about 200 volts. The energy converter or power generator may use propane, natural gas, battery, and/or solar power to provide flexibility based on environmental conditions and cost requirements. A propane power solution may include a timeline before refill.

The power solution may be configured to harness a sustainable power source, such as a solar panel. The solar panel may be mounted to the top of the enclosure. Additionally, and/or alternatively, the sustainable power solution may be mounted to a side of the enclosure to receive a maximum amount of sunlight.

The cooler box 130 may be configured to insulated for maintaining a temperature within a temperature range, such as −5° C. to −80° C. The cooler box 130 may be configured to store biomaterials, vaccines, and other temperature-controlled products. The cooler box 130 may be very portable and easy to install. The cooler box 130 may be configured to daisy chain multiple containers together. The cooler box 130 may be configured to maintain a −75° C. temp for up to three days if the Cryo chiller 120 were to shut down. The cooler box 130 may be configured to store products for the semiconductor, chemical, nuclear, pharmaceutical, fuel, and food process industry. The cooler box 130 may be used for the winterization of CBD oils. The cooler box 130 may also be used to store varicella-containing vaccines at −50° C., including VAR, Varivax; ZOS, Zostavax; and MMRV, ProQuad. The cooler box 130 may be configured to store Chimpanzee adenoviral vectors vaccines at −70° C., including Ebola, coronaviruses, MERS CoV and SARS CoV along with recent vaccines treating Covid-19.

The Cryo chiller 120 may include monitoring and control features. The monitoring and control features may be configured to monitor and adjust settings such as temperature, humidity, and/or other settings. The monitoring and control features may control a flow rate of a single fluid and increase the likelihood of a relatively constant overall heat transfer coefficient regardless of a heating or chilling mode. The monitoring and control features may enable absolute temperature control that is replicable from one batch to another. The monitoring and control features may enable the standard temperature control variance to be within +/−0.5° C. to provide batch consistency and validated results.

The Cryo chiller 120 may include safety systems. The safety systems may include high-temperature switches, low-temperature switches, pressure relief valves, thermal fluid pressure switches, low-nitrogen pressure switches, low fluid dry-running detection, and high pressure in the compressor detection. In the case of exceeding allowable limits, the Cryo chiller 120 may be configured to shut down. Additionally, the Cryo chiller 120 may include a suction pressure sensor for freeze protection, a safety temperature limiter, a temperature sensor for a maximum allowable temperature of pressurized gas, and a motor protection sensor.

The Cryo chiller 120 includes various control features. The control features may include a user-interactive display with full diagnostic information & system overview, a large color screen, Ethernet (LAN/WAN) connectivity, WI-Fi connectivity, and 4G Internet connectivity. The Cryo chiller 120 may include cloud-based applications for remote monitoring, Site Service APP, real-time energy monitoring, and performance metering. The applications for the Cryo chiller 120 may be configured to have a full interface with customers with a DCS/SCADA/PCS System. The Cryo chiller 120 may include start/stop and emergency stop buttons. The applications for the Cryo chiller 120 may include built-in energy optimization functionality and a built-in web browser to present system information through either dashboards or automatically generated system graphics.

FIG. 2B illustrates a back view of an embodiment of a non-mobile Cryo chiller storage solution.

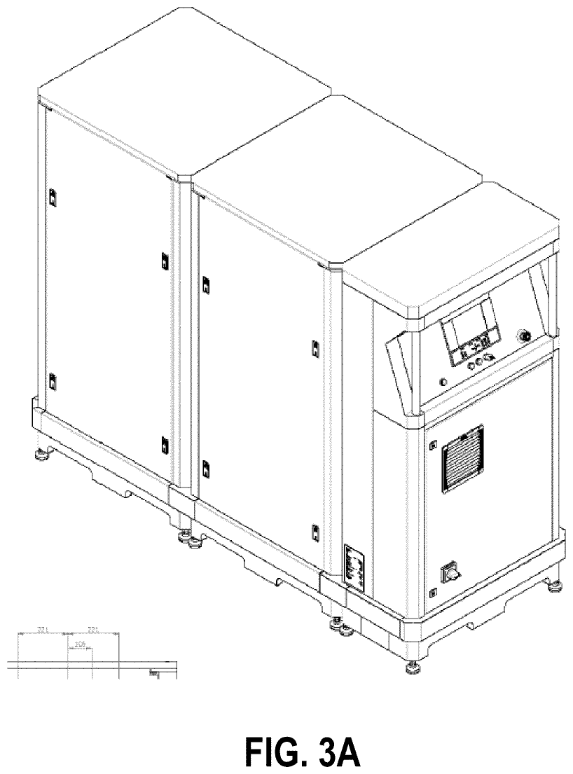

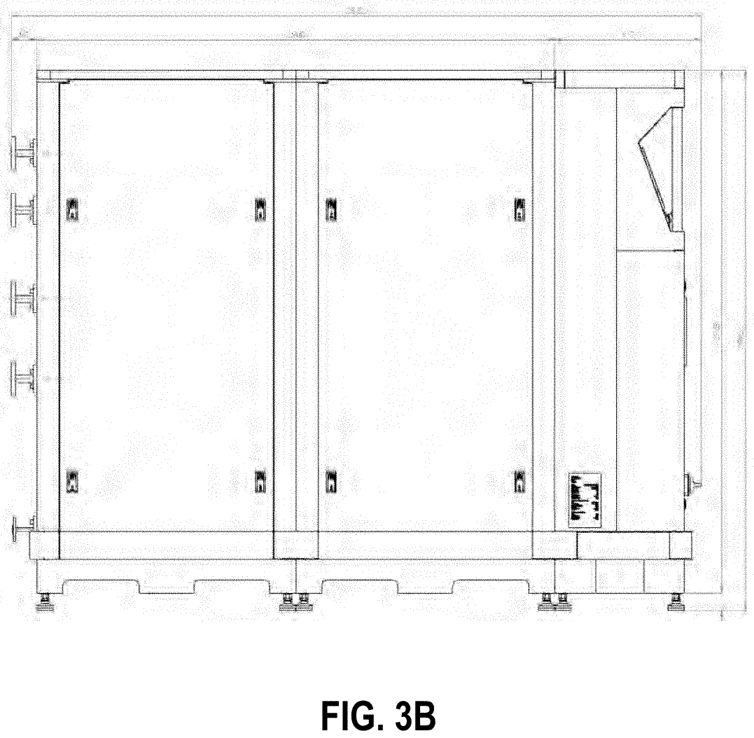

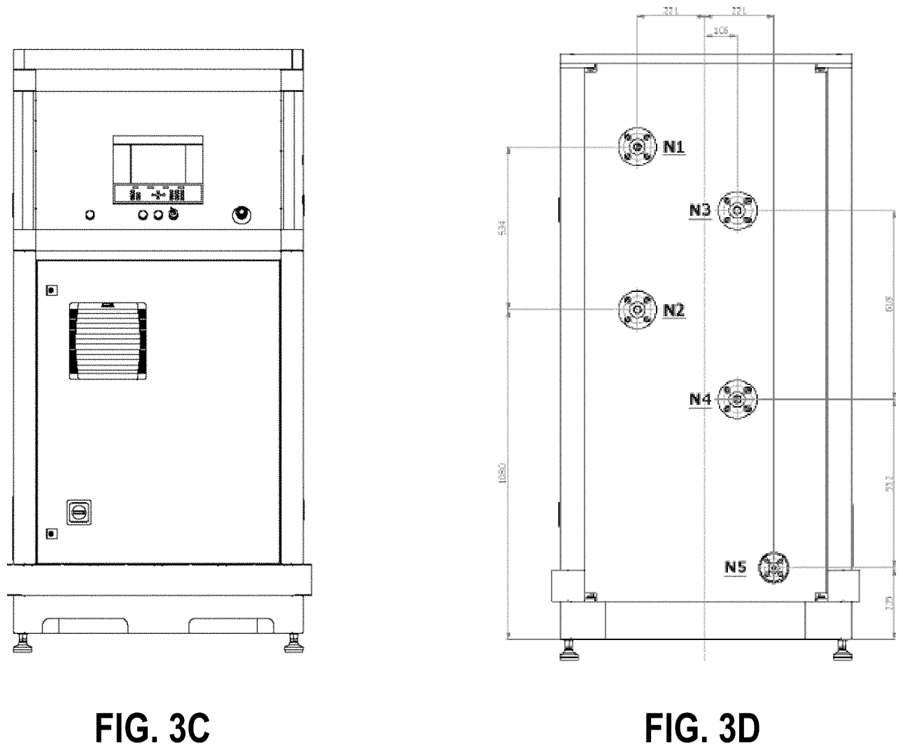

FIG. 3A illustrates an angled view of a schematic of a non-mobile Cryo chiller storage solution.

FIG. 3B illustrates a side view of a schematic of a non-mobile Cryo chiller storage solution.

FIG. 3C illustrates a front view of a schematic of a non-mobile Cryo chiller 120 storage solution.

FIG. 3D illustrates a back view of a schematic of a non-mobile Cryo chiller 120 storage solution. The Cryo chiller 120 may include various inlets and outlets as shown in FIG. 3D. The inlets and outlets may have various cooling capacities. For example, a cooling capacity at an outlet may be 4 kW at −60° C. Max kW@60 Hz per unit and 1.14 at −76° F. Max RT@60 Hz for the system. In another example, a cooling capacity at an inlet may be −55° C. per unit and −67 ° F. for the system. In another example, the cooling capacity at an outlet may be −72° C. per unit and −97° F. for the system. The cooling system may use Syltherm XLT as a cooling fluid medium. In some embodiments, the maximum cooling fluid flow rate is 2.0 m³/hour per unit and 9.26 US GPM for the system. In some embodiments, the COP cooling (EER) is 0.65 per unit.

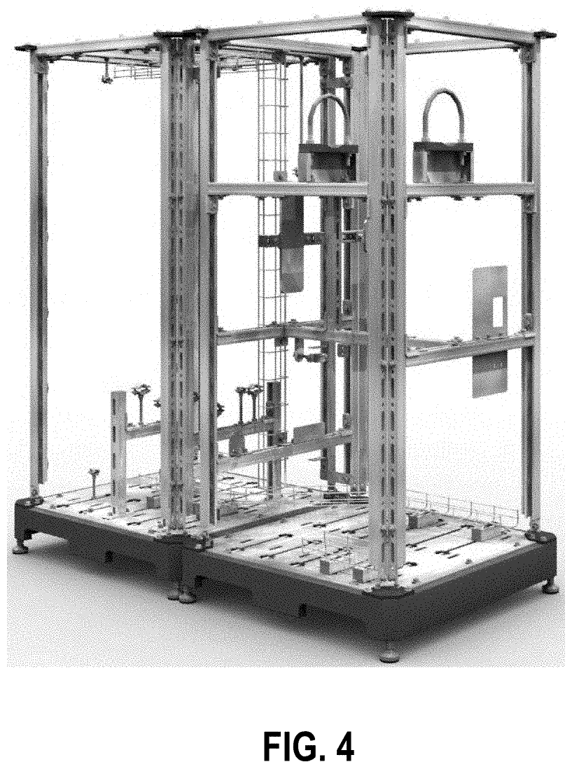

FIG. 4 illustrates a frame for a non-mobile Cryo chiller storage solution.

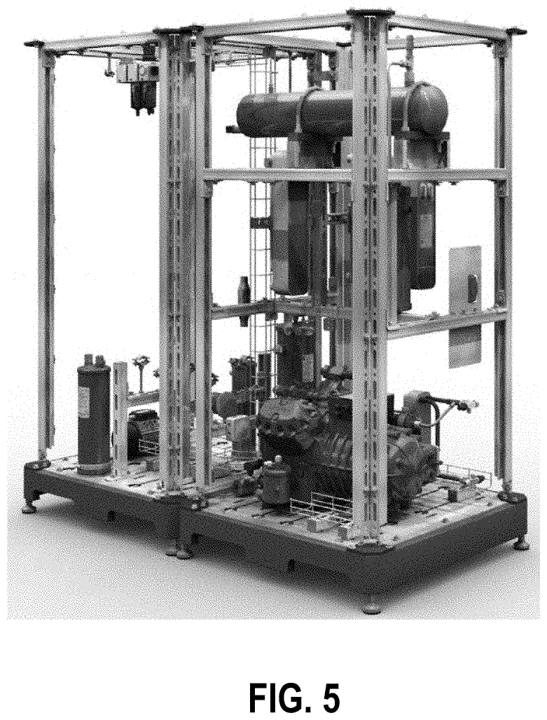

FIG. 5 illustrates a compressor system for a non-mobile Cryo chiller storage solution. The Cryo system may include a compressor. The compressor control type is VSD. The compressor may use a three-phase 208-230V 60 Hz per unit. In some embodiments, the compressor may use reciprocating piston compressors with full VSD drives.

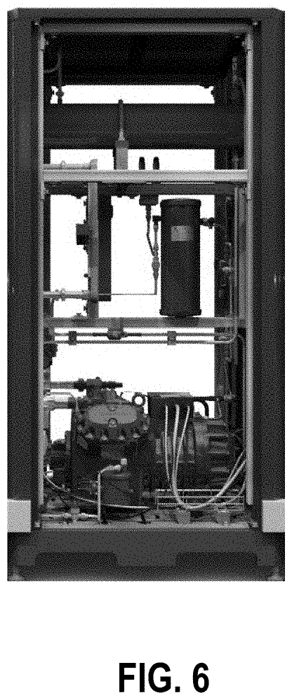

FIG. 6 illustrates a compressor system for a non-mobile Cryo chiller storage solution. In some embodiments, the minimum design temperature may be −80° C. per unit and −100° C. for the system. In some embodiments, the maximum design temperature may be +35° C. per unit and +95° C. for the system.

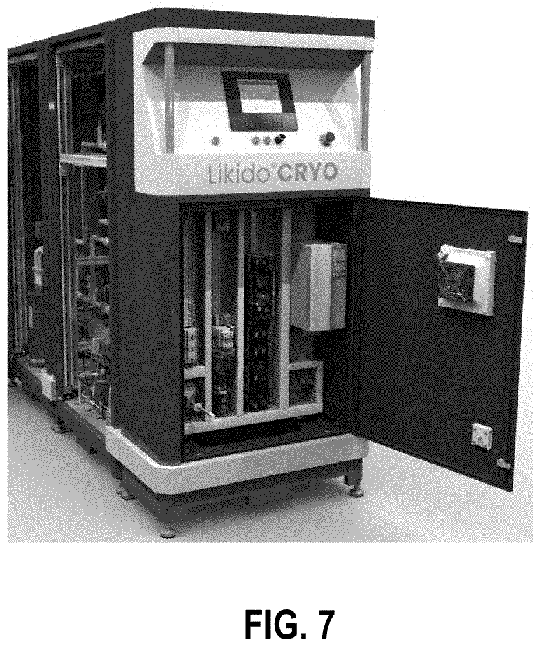

FIG. 7 illustrates an interface paneling for a non-mobile Cryo chiller storage solution. The interface paneling may include monitoring and control features. The monitoring and control features may be configured to monitor and adjust settings such as temperature, humidity, and/or other settings. The monitoring and control features may control a flow rate of a single fluid and increase the likelihood of a relatively constant overall heat transfer coefficient regardless of a heating or chilling mode. The monitoring and control features may enable absolute temperature control that is replicable from one batch to another. The monitoring and control features may enable the standard temperature control variance to be within +/−0.5° C. to provide batch consistency and validated results.

The interface paneling may include safety systems. The safety systems may include high-temperature switches, low-temperature switches, pressure relief valves, thermal fluid pressure switches, low-nitrogen pressure switches, low fluid dry-running detection, and high pressure in the compressor detection. In the case of exceeding allowable limits, the Cryo chiller 120 may be configured to shut down. Additionally, the Cryo chiller 120 may include a suction pressure sensor for freeze protection, a safety temperature limiter, a temperature sensor for a maximum allowable temperature of pressurized gas, and a motor protection sensor.

The interface paneling includes various control features. The control features may include a user-interactive display with full diagnostic information & system overview, a large color screen, Ethernet (LAN/WAN) connectivity, WI-Fi connectivity, and 4G Internet connectivity. The Cryo chiller 120 may include cloud-based applications for remote monitoring, Site Service APP, real-time energy monitoring, and performance metering. The applications for the Cryo chiller 120 may be configured to have a full interface with customers with a DCS/SCADA/PCS System. The Cryo chiller 120 may include start/stop and emergency stop buttons. The applications for the Cryo chiller 120 may include built-in energy optimization functionality and a built-in web browser to present system information through either dashboards or automatically generated system graphics.

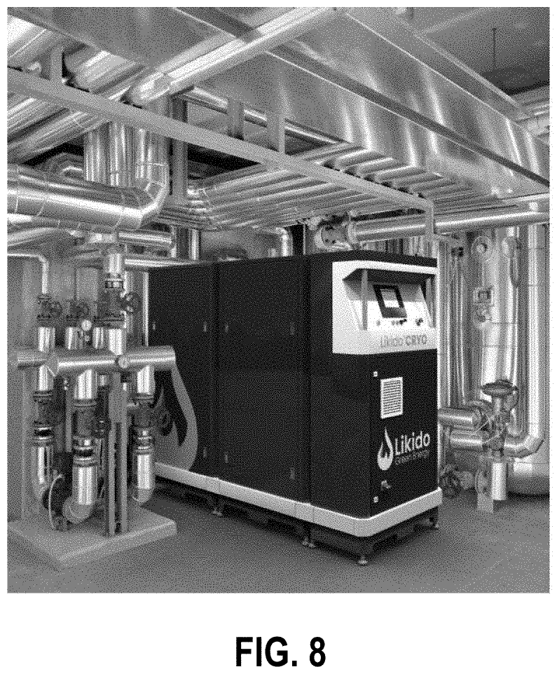

FIG. 8 illustrates an environment for a non-mobile Cryo chiller storage solution. In some embodiments, the minimum design pressure may be −1 bargs per unit and −1 bargs for the system. In some embodiments, the maximum design pressure may be 10 bargs per unit and 10 bargs for the system. In some embodiments, the test pressure may be 24 bargs per unit and 10 bargs for the system.

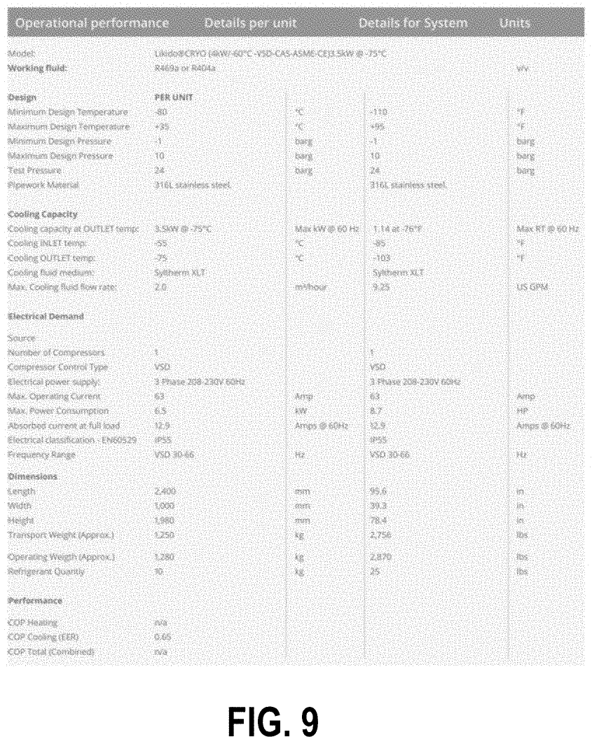

FIG. 9 illustrates a spec sheet for a non-mobile Cryo chiller storage solution.

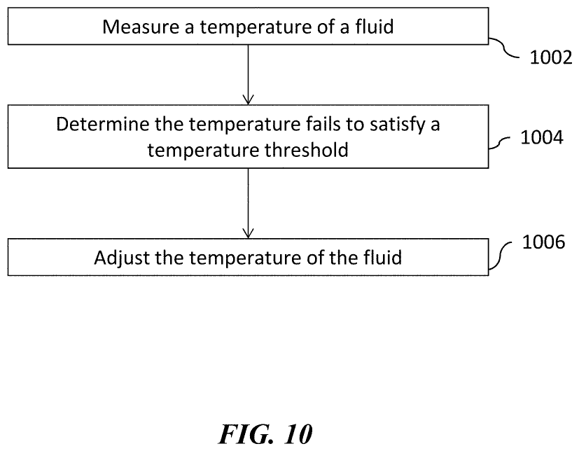

FIG. 10 depicts a flowchart illustrating an example of a process for maintaining a temperature in a cryochiller storage solution, in accordance with some example embodiments; and

At 1002, the Cryo chiller 120 may measure a temperature of a fluid incoming to the Cryo chiller 120 at an inlet. In some embodiments, the Cryo chiller 120 may measure the temperature of a fluid at a cooler box 130. For example, the Cryo chiller 120 may measure the temperature of the fluid incoming to the Cryo chiller 120 at the inlet as −50° C. In another example, the Cryo chiller 120 may measure the temperature of the fluid incoming to the cooler box 130 as −60° C.

At 1004, the Cryo chiller 120 may determine a temperature of a fluid incoming to the Cryo chiller 120 at an inlet does not satisfy a threshold. In some embodiments, the Cryo chiller 120 may determine the temperature of a fluid at a cooler box 130 does not satisfy a threshold. For example, the Cryo chiller 120 may determine the temperature of −50° C. of the fluid incoming to the Cryo chiller 120 at the inlet does not satisfy a threshold of −80° C. In another example, the Cryo chiller 120 may determine the temperature of −60° C. of the fluid incoming to the cooler box 130 does not satisfy a threshold of −70° C.

At 1006, the Cryo chiller 120 may adjust a temperature of a fluid leaving the Cryo chiller 120 at an outlet in response to the threshold not being satisfied. In some embodiments, the Cryo chiller 120 may adjust a temperature of the fluid at a cooler box 130 in response to the threshold not being satisfied. For example, the Cryo chiller may adjust the temperature of the fluid leaving to the Cryo chiller at the outlet to −80° C. In another example, the Cryo chiller 120 may adjust the temperature of the fluid incoming to the cooler box 130 to −70° C.

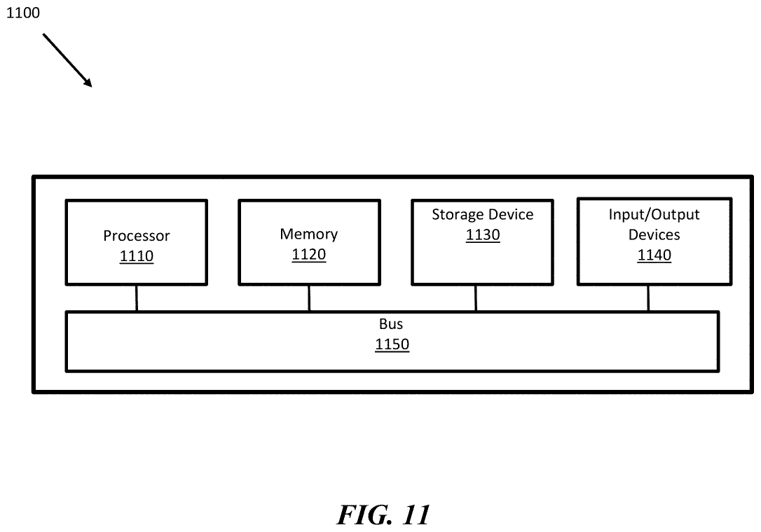

FIG. 11 depicts a block diagram illustrating an example of a computing system 1100 consistent with implementations of the current subject matter. Referring to FIGS. 1-11, the computing system 1100 may be used to implement the autoencoder 902 and/or any component therein. For example, the computing system 1100 may implement a user equipment, a personal computer, or a mobile device.

As shown in FIG. 11, the computing system 1100 may include a processor 1110, a memory 1120, a storage device 1130, and an input/output device 1140. The processor 1110, the memory 1120, the storage device 1130, and the input/output device 1140 may be interconnected via a system bus 1150. The processor 1110 is capable of processing instructions for execution within the computing system 1100. Such executed instructions may implement one or more components of, for example, the autoencoder 902 for performing batch normalization. In some example embodiments, the processor 1110 may be a single-threaded processor. Alternately, the processor 1110 may be a multi-threaded processor. The processor 1110 is capable of processing instructions stored in the memory 1120 and/or on the storage device 1130 to display graphical information for a user interface provided via the input/output device 1140.

The memory 1120 is a non-transitory computer-readable medium that stores information within the computing system 1100. The memory 1120 may store data structures representing configuration object databases, for example. The storage device 1130 is capable of providing persistent storage for the computing system 1100. The storage device 1130 may be a floppy disk device, a hard disk device, an optical disk device, or a tape device, or other suitable persistent storage means. The input/output device 1140 provides input/output operations for the computing system 1100. In some example embodiments, the input/output device 1140 includes a keyboard and/or pointing device. In various implementations, the input/output device 1140 includes a display unit for displaying graphical user interfaces.

According to some example embodiments, the input/output device 1140 may provide input/output operations for a network device. For example, the input/output device 1140 may include Ethernet ports or other networking ports to communicate with one or more wired and/or wireless networks (e.g., a local area network (LAN), a wide area network (WAN), the Internet, a public land mobile network (PLMN), and/or the like).

In some example embodiments, the computing system 1100 may be used to execute various interactive computer software applications that may be used for organization, analysis, and/or storage of data in various formats. Alternatively, the computing system 1100 may be used to execute any type of software applications. These applications may be used to perform various functionalities, e.g., planning functionalities (e.g., generating, managing, editing of spreadsheet documents, word processing documents, and/or any other objects, etc.), computing functionalities, communications functionalities, etc. The applications may include various add-in functionalities or may be standalone computing items and/or functionalities. Upon activation within the applications, the functionalities may be used to generate the user interface provided via the input/output device 1140. The user interface may be generated and presented to a user by the computing system 1100 (e.g., on a computer screen monitor, etc.)

### Terminology

After reading this description, it will become apparent to one skilled in the art how to implement the present disclosure in various alternative embodiments and alternative applications. However, all the various embodiments of the present invention will not be described herein. It will be understood that the embodiments presented here are presented by way of an example only, and not limitation. As such, this detailed description of various alternative embodiments should not be construed to limit the scope or breadth of the present disclosure as set forth herein.

Before the present technology is disclosed and described, it is to be understood that the aspects described below are not limited to specific compositions, methods of preparing such compositions, or uses thereof as such may, of course, vary. It is also to be understood that the terminology used herein is for the purpose of describing particular aspects only and is not intended to be limiting.

The detailed description divided into various sections only for the reader's convenience and disclosure found in any section may be combined with that in another section. Titles or subtitles may be used in the specification for the convenience of a reader, which are not intended to influence the scope of the present disclosure.

Unless defined otherwise, all technical and scientific terms used herein have the same meaning as commonly understood by one of ordinary skill in the art to which this disclosure belongs. In this specification and in the claims that follow, reference will be made to a number of terms that shall be defined to have the following meanings:

The terminology used herein is for the purpose of describing particular embodiments only and is not intended to be limiting. As used herein, the singular forms “a”, “an” and “the” are intended to include the plural forms as well, unless the context clearly indicates otherwise.

“Optional” or “optionally” means that the subsequently described event or circumstance can or cannot occur, and that the description includes instances where the event or circumstance occurs and instances where it does not.

The term “about” when used before a numerical designation, e.g., temperature, time, amount, concentration, and such other, including a range, indicates approximations which may vary by (+) or (−) 10%, 5%, 1%, or any subrange or subvalue there between. Preferably, the term “about” when used with regard to a dose amount means that the dose may vary by +/−10%.

“Comprising” or “comprises” is intended to mean that the compositions and methods include the recited elements, but not excluding others. “Consisting essentially of” when used to define compositions and methods, shall mean excluding other elements of any essential significance to the combination for the stated purpose. Thus, a composition consisting essentially of the elements as defined herein would not exclude other materials or steps that do not materially affect the basic and novel characteristic(s) of the claimed invention. “Consisting of” shall mean excluding more than trace elements of other ingredients and substantial method steps. Embodiments defined by each of these transition terms are within the scope of this disclosure.

Unless otherwise defined, all terms of art, notations, and other scientific terms or terminology used herein are intended to have the meanings commonly understood by those skilled in the art to which this application pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described or referenced herein are well understood and commonly employed using conventional methodology by those skilled in the art.

The singular form “a”, “an”, and “the” include plural references unless the context clearly dictates otherwise. For example, the term “a cell” includes one or more cells, comprising mixtures thereof. “A and/or B” is used herein to include all of the following alternatives: “A”, “B”, “A or B”, and “A and B”.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number. If the degree of approximation is not otherwise clear from the context, “about” means either within plus or minus 10% of the provided value, or rounded to the nearest significant figure, in all cases inclusive of the provided value. In some embodiments, the term “about” indicates the designated value up to ±10%, up to ±5%, or up to ±1%.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination. All combinations of the embodiments pertaining to the disclosure are specifically embraced by the present disclosure and are disclosed herein just as if each and every combination was individually and explicitly disclosed. In addition, all sub-combinations of the various embodiments and elements thereof are also specifically embraced by the present disclosure and are disclosed herein just as if each and every such sub-combination was individually and explicitly disclosed herein

What is claimed is:

1. A device for transporting and storage of temperature sensitive materials comprising:
a Generator Power solution;
a Cryo Cooling chiller;
a chiller storage unit;
a continuous flow process to the chiller storage unit, enabling it to maintain a temperature of between about −5° C. and about −80° C.; and
at least one of a condensed mobile structure and non-mobile structure.

2. The device of claim 1, wherein the generator power solution creates sufficient power to run the Cryo Cooling Chiller directly from solar or propane tank.

3. The device of claim 1, wherein the cryo cooling chiller cools the chiller storage unit to between about −50° C. and about −80° C.

4. The device of claim 1, wherein the cryo cooling chiller cools the chiller storage unit to about −75° C.

5. The device of claim 1, wherein the Generator Power solution is the condensed mobile structure.

6. The device of claim 1, wherein the temperature sensitive materials are safely stored and/or transported in the chiller storage unit.

7. A device for transportation and/or storage of a temperature sensitive material comprising:
a power system;
a refrigeration system;
a storage unit comprising a compartment configured to hold the temperature sensitive material; and
a storage structure configured to house the power system, the refrigeration system and the storage unit.

8. The device of claim 7, wherein the power system is configured to provide sufficient power to run the refrigeration system for a period of at least 15 days without recharging.

9. The device of claim 7, wherein the power system includes a generator, solar panels, batteries, or wired electricity.

10. The device of claim 9, wherein the generator is fueled by natural gas, propane, or other fuel.

11. The device of claim 7, wherein the refrigeration system is configured to cool the storage unit to between about −5° C. and about −80° C.

12. The device of claim 7, wherein the storage unit is supercritically chilled using carbon dioxide.

13. The device of claim 7, wherein the storage structure is configured to be mobile.

14. The device of claim 7, wherein the storage structure the power system, the refrigeration system, and the storage unit comprise a self-contained, closed system.

15. The device of claim 7, wherein the device is configured to be remotely monitored in real time.

16. The device of claim 7, wherein the device is configured to remotely control one or more device settings including temperature, humidity, pressure, flow, location, stability, power consumption, power remaining, and storage capacity remaining.

17. The device of claim 7, wherein the storage unit comprises a plurality of compartments configured to hold the temperature sensitive material.

18. A method comprising:
measuring a temperature of a fluid incoming to a refrigeration system,
determining the temperature of the fluid does not satisfy a temperature threshold; and
adjusting, by the refrigeration system in response to determining the temperature of the fluid does not satisfy the temperature threshold, the temperature at the refrigeration system.

19. The method of claim 18, wherein the temperature is measured at a storage box.

20. The method of claim 18, wherein the temperature threshold is between about −5° C. and about −80° C.
